(19) United States
(12) Patent Application Publication
(10) Pub. No.: US 2015/0178266 A1
(43) Pub. Date: Jun. 25, 2015

(54) ENTITY-BASED SUMMARIZATION FOR ELECTRONIC BOOKS

(71) Applicant: Google Inc., Mountain View, CA (US)

(72) Inventors: Chris Navrides, Santa Clara, CA (US); Tuna Toksoz, Mountain View, CA (US)

(73) Assignee: Google Inc., Mountain View, CA (US)

(21) Appl. No.: 14/137,597

(22) Filed: Dec. 20, 2013

(51) Int. Cl. G06F 17/27

(52) U.S. Cl. CPC G06F 17/279

(57) ABSTRACT

An entity-based summary of an electronic book (e-book) is presented to a user of a client device. The e-book to be summarized is identified and multiple entities, e.g., characters, events and dates, referenced in the identified e-book are also identified. A computer server is adapted to determine a type of the e-book to be summarized and to identify one or more external data sources based on the determined type of the e-book, where an external data source provides information about entities in the identified e-book. Upon receiving a request for an entity-based summary of the e-book from the client device, the computer server is adapted to generate an entity-based summary of the e-book, which describes identified entities referenced in a range of the e-book specified in the request. The generated entity-based summary is presented to the client device responsive to the request.

### TECHNICAL FIELD

The disclosure relates generally to the field of electronic media, and specifically to entity-based summarization for electronic books.

### BACKGROUND

The development of electronic books (e-books) has enabled many features to enhance the user reading experience. However, reading a book takes time, e.g., it may take a reader weeks, months, or even years to complete a particular book. Thus, a reader may forget important information about characters, places, dates and events within the book. Further, many readers may read multiple books at the same time, making it even harder to remember what has already been read.

Searching back through a book to reread portions of the book can significantly add to the amount of time a reader has to spend in reading the book. Instead of rereading portions of the book, a reader may attempt to discover information by searching the Internet. However, this approach exposes the user to the risk of discovering information about portions of the book he or she has not read.

### SUMMARY

A computer-implemented method for presenting an entity-based summary of an electronic book (e-book) is disclosed. Embodiments of the method comprise identifying the e-book to be summarized and identifying multiple entities, e.g., characters, events and dates, referenced in the identified e-book. The embodiments of the method also comprise determining a type of the e-book to be summarized and identifying one or more external data sources based on the determined type of the e-book, where an external data source provides information about entities in the identified e-book. Upon receiving a request for an entity-based summary of the e-book, an entity-based summary of the e-book is generated, which describes identified entities referenced in a range of the e-book specified in the request. The generated entity-based summary is presented responsive to the request.

Another aspect provides a client device for presenting an entity-based summary of an e-book. One embodiment of the client device has a computer processor for executing computer program modules and a non-transitory computer readable storage device storing computer program modules. The computer program modules are executable to perform steps comprising identifying an e-book to be summarized and providing a request for an entity-based summary of the e-book to a server. The request identifies a specified range of the e-book between a start point and a break point. The server is adapted to identify multiple entities referenced in the text of the identified e-book, generate an entity-based summary of the e-book and provide the generated entity-based summary to the client device for presentation.

Another aspect provides a non-transitory computer-readable storage medium storing executable computer program instructions for presenting an entity-based summary of an e-book. The computer-readable storage medium stores computer program instructions comprising instructions for identifying the e-book to be summarized and identifying multiple entities referenced in the identified e-book. The computer-readable storage medium also stores computer program instructions for receiving a request for an entity-based summary of the e-book, generating an entity-based summary of the e-book and presenting the generated entity-based summary responsive to the request

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE DRAWINGS

FIG. 1 is a high-level block diagram of a computing environment for supporting entity-based summarization according to one embodiment.

FIG. 2 is a high-level block diagram illustrating an example of a computer for acting as a client device and/or store server in one embodiment.

FIG. 3 is a high-level block diagram illustrating a summary subsystem according to one embodiment.

FIG. 4 is a high-level block diagram illustrating a client device according to one embodiment.

FIG. 5 is a flowchart illustrating a process for providing entity-based summarization of an e-book according to one embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### System Overview

In this disclosure, “digital content” generally refers to any machine-readable and machine-storable work product, such as e-books, videos, and music files. The following discussion focuses on e-books. However, the techniques described below can also be used with other types of digital content.

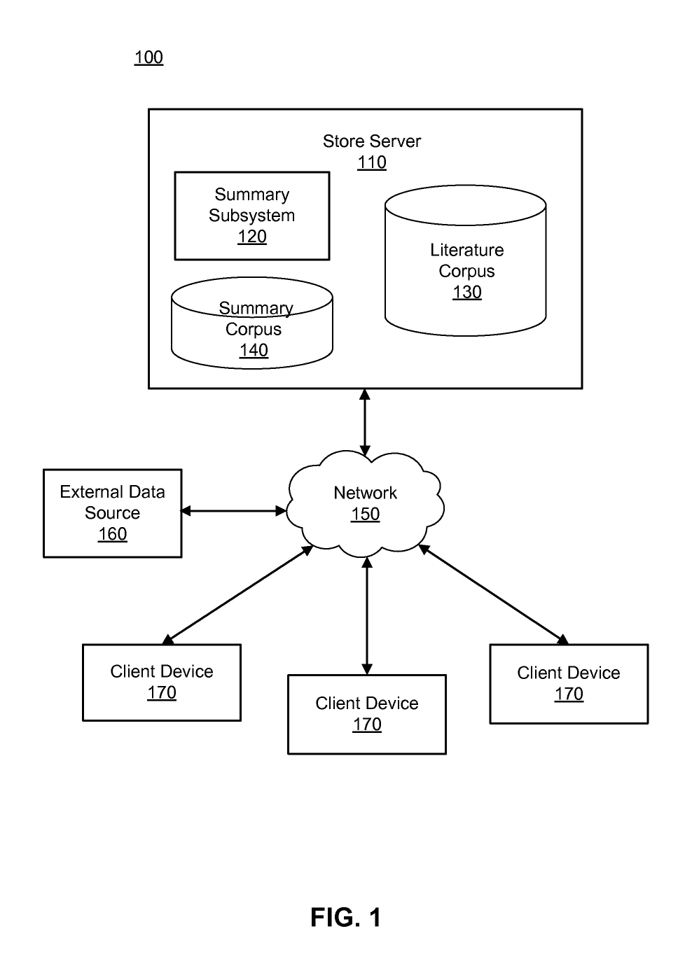

FIG. 1 shows a computing environment 100 for supporting entity-based summarization for e-books according to one embodiment. The computing environment 100 includes a store server 110, a plurality of client devices 170 and an external data source 160 connected by a network 150. Only one store server 110, three client devices 170 and one external data source 160 are shown in FIG. 1 in order to simplify and clarify the description. Embodiments of the computing environment 100 can have many store servers 110, client devices 170 and external data sources 160 connected to the network 150. Likewise, the functions performed by the various entities of FIG. 1 may differ in different embodiments.

The store server 110 stores e-books that are available for purchase, licensing, rental, subscription and/or free download. The e-books can be viewed on the client devices 170. In one embodiment, the store server 110 may provide an online storefront that a user can browse using the client device 170 to identify and obtain e-books and other digital content. In addition, the store server 110 provides entity-based summaries of portions of e-books upon user request. In one embodiment, the store server 110 includes a summary subsystem 120, a literature corpus 130 and a summary corpus 140. Other embodiments of the store server 110 include different and/or additional components. In addition, the functions may be distributed among the components in a different manner than described herein.

The literature corpus 130 includes one or more data storage devices that store digital content (e.g., e-books) that are available for user access from the client devices 170. In one embodiment, the digital content is stored as a set of files and associated metadata. Each file is associated with particular digital content, such as a given e-book, and a single unit of content may be formed of one or more associated files. The metadata for the files describe attributes of the digital content with which the files are associated. In one embodiment, the metadata include a volume identifier (ID) that is a string that uniquely identifies an e-book. In addition, the metadata describe the types of the e-book, e.g., fiction, non-fiction, historical, legal or scientific. The metadata may also describe, for example, the title, author, publisher, classification of the content, and other type of digital content related to the e-book (e.g., movies, TV series or video games derived from the e-book).

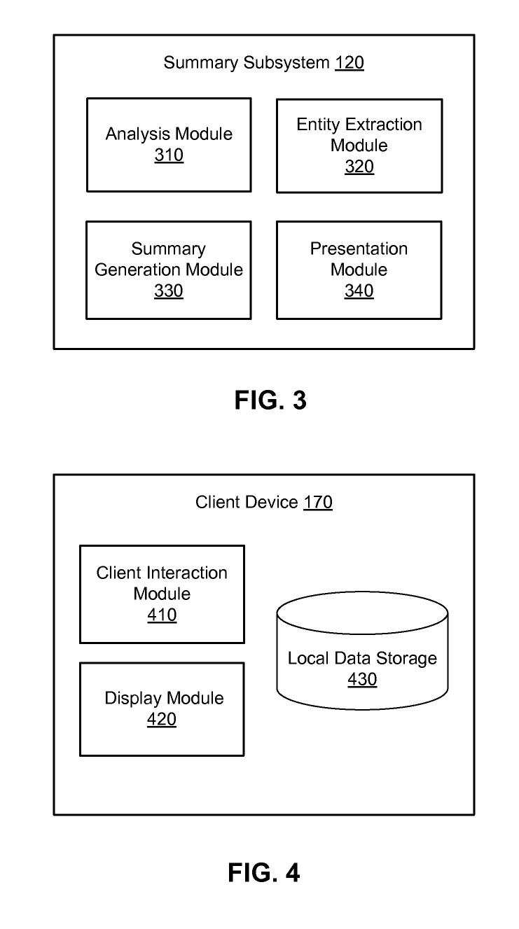

The summary subsystem 120 generates summaries for e-books stored in the literature corpus 130 and stores the summaries in the summary corpus 140. In response to a user request for a summary of a portion of a particular e-book from a client device 170, the summary subsystem 120 generates and/or selects an already-generated summary from the summary corpus 130 for the portion of the e-book. The selected summary is sent via the network 150 to the client device 170 for presentation. The summary subsystem 120 is described in greater detail below with reference to FIG. 3.

The summary corpus 140 includes one or more data storage devices that store summaries of e-books in the literature corpus 130. In one embodiment, the summary of an e-book is entity-based. The term “entity” refers to a subject described in the e-book such as a character, place, date or event. For example, a novel may have multiple characters, places and events related to the development of the story in the novel. Each of such characters, places and events can be an entity of the novel. The entity can be interrelated with one or more other entities of the novel. The summary describes the relationship between the entity and the e-book from a specified start point, such as the beginning of the e-book or a location in the e-book selected by the user as the start point for the summary, to a specified break point. For example, for a character in a novel the summary may describe the activities of the character with respect to the plot of the novel from the start point to the break point.

In one embodiment, the summary corpus 140 stores data describing entities referenced in the e-books. That is, for a given e-book the summary corpus 140 stores data describing the entities referred to the e-book. In addition, the summary corpus 140 stores data describing the locations at which the entities are referenced in the e-book. Upon receipt of a summary request from a user identifying a portion of the e-book, the summary subsystem 120 interacts with the summary data in the summary corpus 140 to generate an entity-based summary of the portion of the e-book identified in the request. The portion may be specified as a range between a start point and a break point in the book.

The network 150 enables communications among the store server 110, client devices 170 and the external data source 160 and can comprise the Internet. In one embodiment, the network 150 uses standard communications technologies and/or protocols. In another embodiment, the entities can use custom and/or dedicated data communications technologies instead of, or in addition to, the ones described above.

The external data source 160 includes one or more data storage devices that store information external to e-books in the literature corpus 130. In one embodiment, an external data source 160 provides information about entities of the e-books in the literature corpus 130. For example, the external data sources may include online encyclopedias that describe real-world entities, such as historical figures, and online databases describing fictional entities, such as characters in movies and/or novels. As such, the external data sources may contain information about entities referenced in the e-books in the literature corpus. In addition, the external data sources may contain information associated with the e-books, such as the text and/or descriptions of other books written by an author of a given e-book.

A client device 170 is an electronic device used by a user to perform functions such as consuming digital content including entity-based e-book summaries, executing software applications, browsing websites hosted by web servers on the network 150, downloading files, and interacting with the store server 110. For example, the client device 170 may be a dedicated e-Reader, a smart phone, or a tablet, notebook, or desktop computer. The client device 170 includes and/or interfaces with a display device on which the user may view the text of e-books and other digital content. In addition, the client device 170 provides a user interface (UI), such as physical and/or on-screen buttons, with which the user may interact with the client device 170 to perform functions such as consuming digital content, selecting digital content, obtaining samples of digital content, and purchasing digital content. An exemplary client device 170 is described in more detail below with reference to FIG. 4.

In situations in which the systems discussed here collect personal information about users, or may make use of personal information, the users may be provided with an opportunity to control whether programs or features collect user information (e.g., information about e-books a user has read, a user's social network, social actions or activities, profession, a user's preferences, or a user's current location), or to control whether and/or how to receive content from the store server 110 that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the store server 110.

### Computing System Architecture

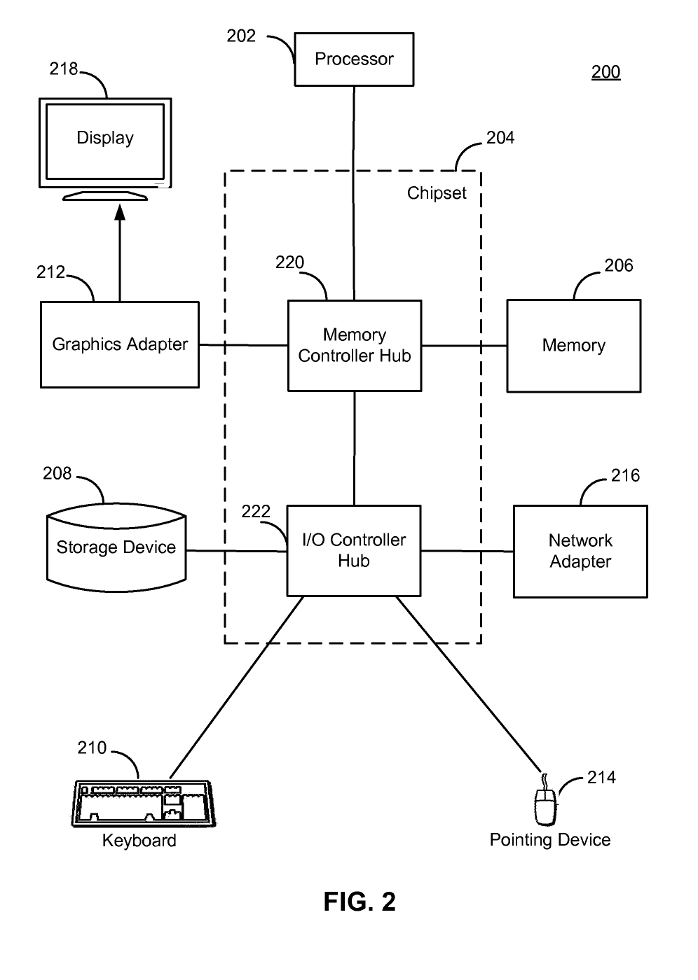

The entities shown in FIG. 1 are implemented using one or more computers. FIG. 2 is a high-level block diagram of a computer 200 for acting as the store server 110, the external data source 160 and/or a client device 170. Illustrated are at least one processor 202 coupled to a chipset 204. Also coupled to the chipset 204 are a memory 206, a storage device 208, a keyboard 210, a graphics adapter 212, a pointing device 214, and a network adapter 216. A display 218 is coupled to the graphics adapter 212. In one embodiment, the functionality of the chipset 204 is provided by a memory controller hub 220 and an I/O controller hub 222. In another embodiment, the memory 206 is coupled directly to the processor 202 instead of the chipset 204.

The storage device 208 is any non-transitory computer-readable storage medium, such as a hard drive, compact disk read-only memory (CD-ROM), DVD, or a solid-state memory device. The memory 206 holds instructions and data used by the processor 202. The pointing device 214 may be a mouse, track ball, or other type of pointing device, and is used in combination with the keyboard 210 to input data into the computer system 200. The graphics adapter 212 displays images and other information on the display 218. The network adapter 216 couples the computer system 200 to the network 150.

As is known in the art, a computer 200 can have different and/or other components than those shown in FIG. 2. In addition, the computer 200 can lack certain illustrated components. For example, the computers acting as the store server 110 can be formed of multiple blade servers linked together into one or more distributed systems and lack components such as keyboards and displays. Moreover, the storage device 208 can be local and/or remote from the computer 200 (such as embodied within a storage area network (SAN)).

As is known in the art, the computer 200 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 208, loaded into the memory 206, and executed by the processor 202.

### Entity-Based Summarization of E-Books

FIG. 3 is a high-level block diagram illustrating a summary subsystem 120 of the store server 110 for supporting entity-based summaries according to one embodiment. In the embodiment shown, the summary subsystem 120 has an analysis module 310, an entity extraction module 320, a summary generation module 330 and a presentation module 340. Those of skill in the art will recognize that other embodiments of the summary subsystem 120 can have different and/or additional modules other than the ones described here, and that the functions may be distributed among the modules in a different manner.

The analysis module 310 identifies an e-book to be summarized. In one embodiment, the analysis module 310 identifies an e-book to be summarized upon a user request for a summary sent to the store server 110. The user request includes an identification of the e-book, such as a volume ID, title or the International Standard Book Number (ISBN) number of the e-book. The user request may also include a start point and/or break point for the identified e-book. The analysis module 310 searches the literature corpus 130 of the server store 110 based on the identification of the requested e-book. In another embodiment, the analysis module 310 automatically identifies an e-book to be summarized upon the e-book being stored in the literature corpus 130.

The analysis module 310 also determines the type of an e-book to be summarized. In one embodiment, the analysis module 310 analyzes the metadata associated with the e-book to categorize the e-book into one or more type categories. The categories can be general or specific. For example, an embodiment of the analysis module 310 may categorize an e-book as belonging to the general category of fiction or non-fiction. The analysis module 310 may then further categorize the e-book with specific categories within the general category (e.g., mystery, historical fiction, biography). The analysis module 310 may also determine the type of the e-book by analyzing the text of the e-book. For example, textual analysis of the book may be performed to determine whether it is fiction or non-fiction if no metadata for the book are available.

The analysis module 310 identifies one or more external data sources for an e-book based on the type of the e-book. The identified external data sources are ones that are likely to have information that will inform the entity identification process for the e-book. For example, if the e-book is determined to be a non-fiction biography, the analysis module 310 may identify one or more external data sources, such as online encyclopedias, that are likely to contain information about the subject of the biography. Similarly, if the e-book is determined to be science fiction, the analysis module 310 may identify one or more external data sources that are likely to contain information about the entities referenced in the book, such as fan sites, movie information sites (in case there is a movie based on the book), etc.

The analysis module 310 interacts with the entity extraction module 320 and the summary generation module 330 for further processing. For example, the analysis module may provide the identity of the e-book, the type of e-book, the identified external data sources, and the start/break points to the entity extraction module 320 and the summary generation module 330.

The entity extraction module 320 extracts one or more entities from the text of an e-book. In other words, the entity extraction module 320 identifies the entities that are referenced in the text of the e-book. The entity extraction module 320 may use one or more of a variety of techniques to extract the entities from the e-book text, including key phrase extraction, text mining, natural language processing, semantic analysis, etc.

An embodiment of the entity extraction module 320 uses information from the identified external data sources to inform the entity extraction process. The information from an external data source may contain an implicit or explicit list of entities referenced in the e-book. Therefore, the entity extraction module 320 can use the external data source to guide and improve the entity extraction process performed on the e-book.

For example, if the e-book is a non-fiction biography of a person, the external data sources may include an online encyclopedia entry describing the life of the person. The online encyclopedia entry may include explicit lists of entities associated with the person, such as locations, dates, and other people who interacted with the person. In addition, the online encyclopedia entry may include headings, tags, links, and the like that implicitly identify entities associated with the person.

In another example, if the e-book is a work of fiction that has also been made into a movie, the external data sources may include a link to an entry for the movie in a movie information database. The movie database entry may include an explicit list of characters in the movie (and hence likely in the e-book), links to other movies or books that are associated with the e-book, etc.

The entity extraction module 320 may parse or otherwise interpret the external data sources in order to identify candidate entities in the e-book. The entity extraction module 320 may then examine the e-book text to identify references to these candidate entities, if any, in the e-book. In addition, the entity extraction module 320 may also discern other information about the entities, such as the relative importance of the entities, from the information in the external data sources.

The entity extraction module 320 stores data describing the entities extracted from an e-book. For a given entity, the data may include the locations in the e-book where the entity is referenced, an indication of the type of entity (e.g., person or location), cross-references to other entities with which the first entity is associated, and locations of text or other information in the e-book that are particularly pertinent to the entity.

The summary generation module 330 generates summaries for e-books stored in the literature corpus 130 using the extracted entities. In one embodiment, the summary generation module 330 automatically and dynamically generates entity-based summaries based on the start and/or break points provided by the requesting user. The entity-based summaries describe the content of the e-book with respect to the individual entities referenced in the e-book in the text delineated by the start and break points. For example, if the received summary request identifies the start point as the beginning of the book and the break point as a location within the text of the book, the summary generation module 330 generates a summary of the e-book text from the start to the location identified by the break point. The generated summary is organized by entity, and describes entities referenced in the e-book between the start point and the break point, using information about the entities from the text between only those two points. The user can refresh his or her recollection of the content of the e-book between the start and break points by, e.g., reading about the characters and other entities described by the e-book between those points.

To generate a summary for an entity, an embodiment of the summary generation module 330 identifies e-book text between the start and break points associated with the entity. The summary generation module 330 then selects a subset of the identified text for inclusion in the summary. The summary generation module 330 perform an analysis of the identified text to assign a weight, or score, to individual text fragments (e.g., sentences, paragraphs) describing amounts of information contributed by the text fragments to the description of the entity, and to the entity's relationships with other entities in the e-book. For example, text fragments that are highly-descriptive, describe interactions with other entities, and the like, may be weighted more heavily than text fragments that lack these features. The summary generation module 330 selects the highest-weighted text fragments for an entity for inclusion in the summary of the entity.

The presentation module 340 presents the entity-based summaries of the e-books in response to requests received from the client devices 170. In one embodiment, the user request includes an identification of a specific e-book and a start point and a break point of the identified e-book. The presentation module 340 provides this information to the summary generation module 330, and receives the requested summary in response thereto. The presentation module 340 then presents the summary to the requesting client device 170.

The specific presentation of the summary can vary in different embodiments. In one embodiment, the presentation module 340 presents the summary as a list of entities referenced in the e-book between the start and the break points. The user can browse through the list of the entities and select one or more of them. The presentation module 340 presents a summary of a selected entity based on information in the e-book found between the start and break points. The summary of the selected entity may include, for example, a description of the entity and how the entity interacts with other entities in the e-book, the locations in the e-book where the entity is referenced, an indication of the type of the entity (e.g. person or location), cross-references to other entities associated with the selected entity within the text between the start and break points and locations of text.

The presentation module 340 may rank the entities in the list based on the importance of the entity to the e-book and/or to the range of pages between the start and break points. The ranking may be based, for example, on the frequency that the individual entities are mentioned in the portion of the e-book between the start and break points, importance information about the entities derived from the external data sources 160, and/or other signals of relative importance.

FIG. 4 is a high-level block diagram illustrating a client device 170 for presenting an e-book and an entity-based summary of the e-book to a user according to one embodiment. The client device 170 shown includes a client interaction module 410, a display module 420 and local data storage 430. Other embodiments of client devices 170 include different and/or additional modules. In addition, the functions may be distributed among the modules in a different manner than described herein.

The client interaction module 410 processes user requests made via user input into the client device 170. One type of the user requests is a request for a particular e-book. Upon receiving a user request for an e-book, the client interaction module 410 searches for the requested e-book at the local data storage 430. If there is a copy of the e-book in the local data storage 430 (e.g., purchased from GOOGLE PLAY STORE™), the client interaction module 410 instructs the display module 420 to retrieve at least part of the requested e-book and present it to the user. Responsive to no copy of the requested e-book being stored in the local data storage 430, the client interaction module 410 may instruct the display module 420 to access a remote copy of the e-book stored in the literature corpus 130 via the network 150.

The client interaction module 410 also receives user requests for entity-based summaries of e-books being displayed on the client devices 170 of the users. For example, the client interaction module 410 may detect when the user interacts with the user interface to request a summary of the e-book. The client interaction module 410 sends the user request with the specified start and break points to the store server 110. The client interaction module 410 may infer the start and break points from the user's previous interactions with the book. For example, the module 410 may infer that the start point is the beginning of the e-book and the break point is the farthest location read by the user in the e-book. The break point may be a location prior to the end of the e-book, and the range of the book defined by the start and break points is thus a subset of the text of the e-book. In addition, the start and break points may be explicitly specified by the user.

The display module 420 receives the entity-based e-book summary from the store server 110 and displays, or otherwise presents, the e-book summary to the user of the client device 170. The display module 420 may also present the text of the e-book and/or other information associated with the e-book. For example, the display module 420 may display a summary of an entity referenced in the identified portion of the e-book while simultaneously displaying pages of e-book text on which the entity is referenced.

### Exemplary Method

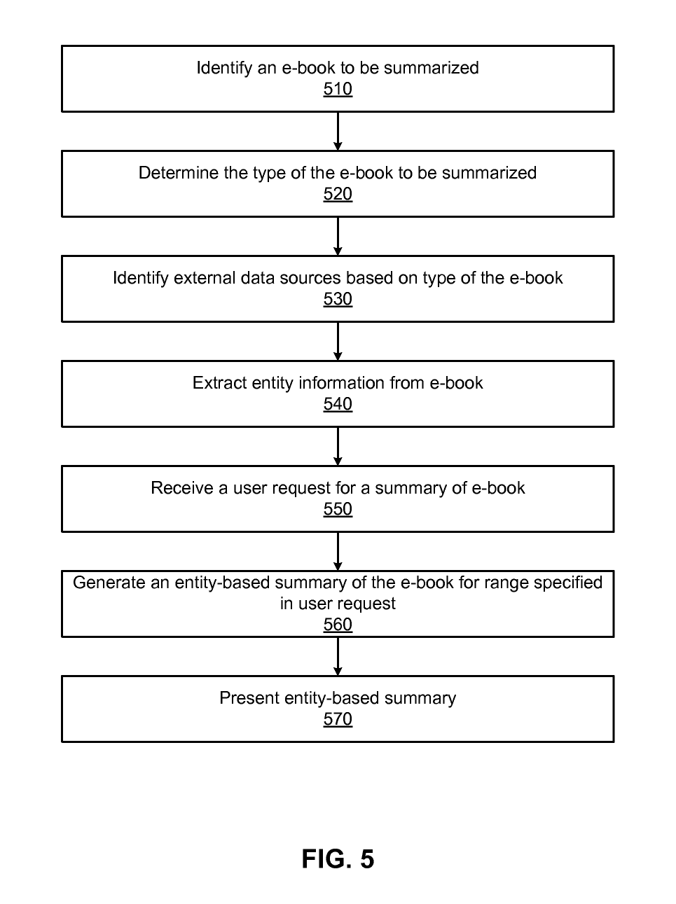

FIG. 5 is a flowchart illustrating a process for providing entity-based summarization of an e-book according to one embodiment. FIG. 5 attributes the steps of the process to the summary subsystem 120. However, some or all of the steps may be performed by other entities. In addition, some embodiments may perform the steps in parallel, perform the steps in different orders, or perform different steps.

Initially, the summary subsystem 120 identifies 510 an e-book to be summarized. As described previously with regard to FIG. 3, the summary subsystem 120 may identify an e-book to be summarized upon receiving a user request for a summary. The summary subsystem 120 may also identify the e-book to be summarized upon occurrence of another event, such as the e-book being added to the literature corpus 130, or a summary process being initiated upon multiple e-books in the corpus.

The summary subsystem 120 determines 520 the type of the e-book to be summarized. Based on the metadata associated with the e-book, the summary subsystem 120 categorizes the e-book into one or more general type categories, e.g., fiction or non-fiction. The summary subsystem 120 may further categorize the e-book with specific categories within the general category (e.g., mystery, historical fiction). Alternatively, the summary subsystem 120 determines the type of the e-book by analyzing the text of the e-book.

The summary subsystem 120 also identifies 530 one or more external data sources based on the type of the e-book. The identified external data sources are ones that are likely to have information that help the summary subsystem 120 to identify entities referenced in the e-book. The summary subsystem 120 identifies 540 entities referenced in the text of the e-book and extracts information about the entities. The summary subsystem 120 may use one or more of a variety of techniques to identify the entities in the e-book text, including using information from the identified external data sources 160 associated with the e-book.

At step 550, the summary subsystem 120 receives a user request for the summary of a portion of an e-book. The user request identifies a range of an e-book for which the summary is requested. The range is defined by start and break points, such as the beginning of the e-book and the farthest point to which the user has read. In one embodiment, the summary subsystem 120 dynamically generates 560 an entity-based summary of the e-book for the range specified in the user request. The summary describes the identified entities referenced in the specified range of the e-book.

The summary subsystem 120 presents 570 the entity-based summary to the requesting user. The user can use the entity-based summary to refresh his or her recollection of the content of the e-book without risk of discovering information about the portions of the book he or she has not read.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

What is claimed is:

1. A computer-implemented method of presenting an entity-based summary of an electronic book (e-book), the method comprising:
identifying an e-book to be summarized;
identifying a plurality of entities referenced in text of the identified e-book;
receiving a request for an entity-based summary of the e-book, the request identifying a specified range of the e-book between a start point and a break point;
generating an entity-based summary of the e-book, the entity-based summary describing identified entities referenced in the specified range of the e-book; and
presenting the generated entity-based summary responsive to the request.

2. The method of claim 1, further comprising:
determining a type of the e-book to be summarized; and
identifying one or more external data sources based on the determined type of the e-book, an external data source providing information about entities in the identified e-book;
wherein identifying the plurality of entities comprises identifying the plurality of entities responsive to information provided by the external data source.

3. The method of claim 2, wherein determining the type of the e-book comprises:
analyzing metadata associated with the e-book; and
categorizing the e-book into one or more categories responsive to the analysis of the metadata.

4. The method of claim 1, wherein the start point identifies a beginning location in the e-book selected by a user of a client device and the break point identifies a farthest location read in the e-book by the user, wherein the break point identifies a location prior to an end of the e-book.

5. The method of claim 1, wherein generating an entity-based summary of the e-book comprises:
generating descriptions of the identified entities using information about the entities from text of the e-book in only the specified range.

6. The method of claim 5, wherein generating descriptions of the identified entities comprises:
identifying text fragments from the e-book in the specified range between the start point and the break point associated with the identified entities;
assigning weights to the identified text fragments describing amounts of information contributed by the text fragments to the descriptions of the identified entities; and
selecting a subset of the identified text fragments for inclusion in the entity-based summary responsive to the assigned weights.

7. The method of claim 1, wherein presenting the entity-based summary comprises:
ranking the identified entities in a list based on importance of the entities to the e-book; and
presenting the ranked list of entities to a client device.

8. A client device for presenting an entity-based summary of an electronic book (e-book) comprising:
a computer processor for executing computer program modules; and
a non-transitory computer readable storage device storing computer program modules executable to perform steps comprising:
identifying an e-book to be summarized;
providing a request for an entity-based summary of the e-book to a server, the request identifying a specified range of the e-book between a start point and a break point, wherein the server is adapted to:
identify a plurality of entities referenced in text of the identified e-book;
generate an entity-based summary of the e-book, the entity-based summary describing identified entities referenced in the specified range of the e-book; and
provide the generated entity-based summary to the client device responsive to the request; and
presenting the entity-based summary on the client device.

9. The client device of claim 8, wherein the server is further adapted to:
determine a type of the e-book to be summarized; and
identify one or more external data sources based on the determined type of the e-book, an external data source providing information about entities in the identified e-book;
wherein identifying the plurality of entities comprises identifying the plurality of entities responsive to information provided by the external data source.

10. The client device of claim 9, wherein determining the type of the e-book comprises:
analyzing metadata associated with the e-book; and
categorizing the e-book into one or more categories responsive to the analysis of the metadata.

11. The client device of claim 8, wherein generating an entity-based summary of the e-book comprises:
generating descriptions of the identified entities using information about the entities from text of the e-book in only the specified range.

12. The client device of claim 11, wherein generating descriptions of the identified entities comprises:
identifying text fragments from the e-book in the specified range between the start point and the break point associated with the identified entities;
assigning weights to the identified text fragments describing amounts of information contributed by the text fragments to the descriptions of the identified entities; and
selecting a subset of the identified text fragments for inclusion in the entity-based summary responsive to the assigned weights.

13. The client device of claim 8, wherein presenting the entity-based summary comprises:
receiving the identified entities in a list ranked based on importance of the entities to the e-book; and
presenting the ranked list of entities to the client device.

14. A non-transitory computer readable medium storing executable computer program instructions for presenting an entity-based summary of an electronic book (e-book), the computer program instructions comprising instructions for:
identifying an e-book to be summarized;
identifying a plurality of entities referenced in text of the identified e-book;
receiving a request for an entity-based summary of the e-book, the request identifying a specified range of the e-book between a start point and a break point;
generating an entity-based summary of the e-book, the entity-based summary describing identified entities referenced in the specified range of the e-book; and
presenting the generated entity-based summary responsive to the request.

15. The computer-readable storage medium of claim 14, further comprising computer program instructions for:
determining a type of the e-book to be summarized; and
identifying one or more external data sources based on the determined type of the e-book, an external data source providing information about entities in the identified e-book;
wherein identifying the plurality of entities comprises identifying the plurality of entities responsive to information provided by the external data source.

16. The computer-readable storage medium of claim 15, wherein the computer program instructions for determining the type of the e-book comprise computer program instructions for:
analyzing metadata associated with the e-book; and
categorizing the e-book into one or more categories responsive to the analysis of the metadata.

17. The computer-readable storage medium of claim 14, wherein the start point identifies a beginning location in the e-book selected by a user of a client device and the break point identifies a farthest location read in the e-book by the user, wherein the break point identifies a location prior to an end of the e-book.

18. The computer-readable storage medium of claim 14, wherein the computer program instructions for generating an entity-based summary of the e-book comprise computer program instructions for:
generating descriptions of the identified entities using information about the entities from text of the e-book in only the specified range.

19. The computer-readable storage medium of claim 18, wherein the computer program instructions for generating descriptions of the identified entities comprise computer program instructions for:
identifying text fragments from the e-book in the specified range between the start point and the break point associated with the identified entities;
assigning weights to the identified text fragments describing amounts of information contributed to by the text fragments to the descriptions of the identified entities; and
selecting a subset of the identified text fragments for inclusion in the entity-based summary responsive to the assigned weights.

20. The computer-readable storage medium of claim 14, wherein the computer program instructions for presenting the entity-based summary comprise computer program instructions for:
ranking the identified entities in a list based on importance of the entities to the e-book; and
presenting the ranked list of entities to a client device.
